(19) United States
(12) Patent Application Publication
(10) Pub. No.: US 2006/0129520 A1
(43) Pub. Date: Jun. 15, 2006

(54) System and method for automatically updating a program in a computer

(75) Inventor: Yu-Ming Lang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/296,787

(22) Filed: Dec. 7, 2005

(30) Foreign Application Priority Data
Dec. 10, 2004 (TW) 93138280

(51) Int. Cl. G06F 17/30

(52) U.S. Cl. 707/1

(57) ABSTRACT

A method for automatically updating a program in a computer includes the steps of: receiving a new program, and determining whether the new program is compatible with a corresponding old program by comparing a first format description file with a second format description file in a storage of the computer; converting a data format of the new program to a data format which can be compatible with the old program according to a format reference file in the storage; determining whether the new program is compatible with system settings of the computer by comparing a first system settings description file with a second system settings description file in the storage; updating the system settings of the computer to system settings which can be compatible with the new program according to a system settings reference file in the storage; and updating the old program in the storage by the new program. A related system is also disclosed.

### BACKGROUND OF THE INVENTION

1. Field of the Invention

The present invention relates to systems and methods for managing software in a computer system, and more particularly to a system and method for updating a program in the computer system.

2. General Background

Electronic devices have slowly been incorporating computers in recent years. Much of modern progress is associated with the increasing prevalence of the computers. Generally, the computers include one or more processors and memories. The memory stores data and instructions; and the processor manipulates data by executing instructions, which are organized into programs to perform meaningful work. While some programs were quite simple, the size and complexity of the most sophisticated programs have exponentially increased for satisfying the increasing functions of the computers.

Almost inevitably, it becomes necessary or desirable to modify a program for correcting a defect, addressing a compatibility issue with other software or hardware, improving performance, and/or adding features. If no new features are added, the update is called a “patch”; if new features are added, the update is called an “upgrade”. Instead of replacing an entire program, the program can be updated partly. Generally, programs are often configured as a group of files, such as configuration files of a computer system, so that an update installation can simply involve replacing old files with new files.

However, the configuration files must generally be updated by the manufacturer, or by a user in a time-consuming update installation. Further, the update installation can be problematic if the new files incompatible with the old files that are previously compatible. There is no ability to dynamically update the configuration files automatically, or for that matter, to dynamically update the system in general, for example, when a device is added or removed from the computer. There is also no ability to verify the accuracy or compatibility of the configuration files, when a portion of program is added or removed from the configuration files.

What is needed, therefore, is a system for automatically updating a program in a computer, which can dynamically update the programs automatically, and verify the accuracy or compatibility of the programs in the computer.

Similarly, what is also needed is a method for automatically updating a program in a computer, which can dynamically update the programs automatically, and verify the accuracy or compatibility of the programs in the computer.

### SUMMARY

A system for automatically updating a program in a computer in accordance with a preferred embodiment, the computer comprising a processor and a storage. The program updating system includes a program receiving module, a calculating module, a program checking module, a format determining module, a format converting module, a system settings determining module, a system settings updating module, and a program updating module.

The program receiving module is used for receiving a new program to be updated, and storing the new program in the storage. The calculating module is used for calculating a value by adding American Standard Code for Information Interchange (ASCII) data of the new program. The program checking module is used for determining whether the new program is valid by comparing the calculated value with an ASCII a predetermined value of the new program in the storage. The format determining module is used for determining whether a new program is compatible with a corresponding old program in the storage by comparing a first format description file with a second format description file in the storage. The format converting module is used for converting a data format of the new program to a corresponding data format which can be compatible with the old program according to a format reference file in the storage. The system settings determining module is used for determining whether the new program is compatible with system settings of the computer by comparing a first system settings description file with a second system settings description file in the storage. The system settings updating module is used for updating the system settings of the computer to system settings which can be compatible with the new program according to a system settings reference file in the storage. The program updating module is used for updating the old program in the storage by the new program.

Another preferred embodiment provides a method for automatically updating a program in a computer by utilizing the above system. The method includes the steps of: (a) receiving the new program; (b) calculating a value by adding American Standard Code for Information Interchange (ASCII) data of the new program; (c) determining whether the new program is valid by comparing the calculated value with an ASCII a predetermined value of the new program in the storage of the computer; (d) determining whether the new program is compatible with a corresponding old program in the storage by comparing a first format description file with a second format description file in the storage; (e) converting a data format of the new program to a data format which can be compatible with the old program according to a format reference file in the storage, if the updating program is incompatible with the preexisting program; (f) determining whether the new program is compatible with system settings by comparing a first system settings description file with a second system settings description file in the storage; (g) updating the system settings of the computer to system settings which can be compatible with the new program according to a system settings reference file in the storage, if the new program is not compatible with the system settings of the computer; and (h) updating the old program in the storage by the new program.

Other advantages and novel features of the embodiments will be drawn from the following detailed description with reference to the attached drawings, in which:

### BRIEF DESCRIPTION OF THE DRAWINGS

FIG. 1 a schematic diagram of an application environment of a program updating system according to a preferred embodiment of the present invention;

FIG. 2 is a diagram of function modules of the program updating system of FIG. 1; and

FIG. 3 is a flowchart of a preferred method for automatically updating a program in a computer by implementing the system of FIG. 2.

### DETAILED DESCRIPTION OF THE EMBODIMENTS

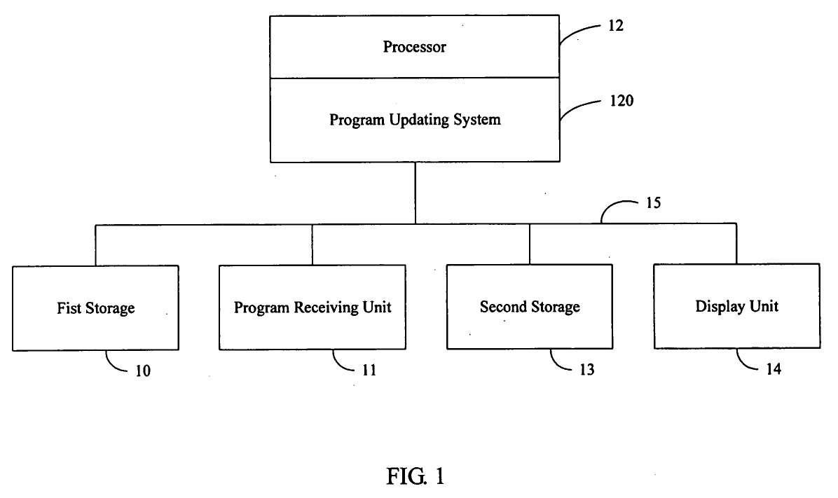

FIG. 1 is a schematic diagram of an application environment of a program updating system according to a preferred embodiment of the present invention. The program updating system 120 can be performed in any computing device or computing system, such as a personal computer or a server. In the preferred embodiment of the present invention, the program updating system is performed in a computer. The computer generally includes a first storage 10, a program receiving unit 11, a processor 12, a second storage 13, a display unit, and a bus 15.

The first storage 10 is typically a non-volatile memory, such as a disk or a flash memory, which is used for storing files including system software, applications, user files, format description files, and system settings description files. The program receiving unit 11 is used for receiving updates like programs to be updated. The processor 12 is used for performing the program updating system 120 to update the programs in the computer. The second storage 13 is typically a dynamical random access memory (DRAM), which is used for storing temporary data processed by the processor 12. The display unit 14 is used for displaying status information during the process of updating the programs. The bus 15 is used for transmitting data among the first storage 10, the program receiving unit 11, the second storage 13, the display unit 14, and the processor 12.

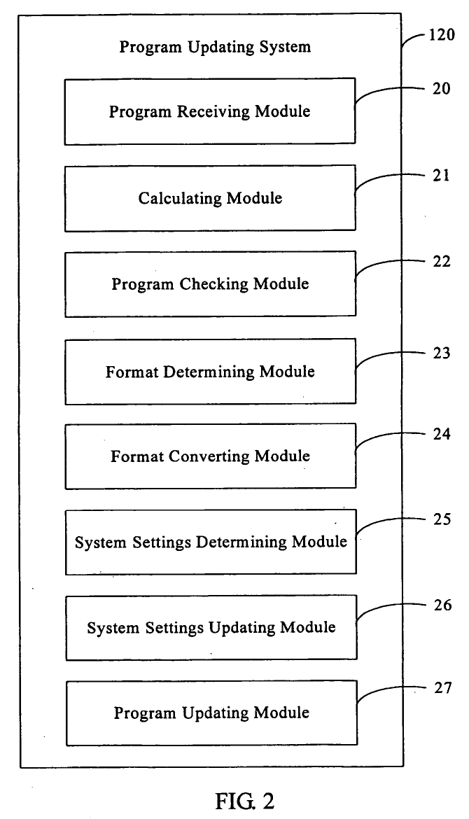

FIG. 2 is a diagram of function modules of the program updating system 120. The program system 120 includes a program receiving module 20, a calculating module 21, a program checking module 22, a format determining module 23, a format converting module 24, a system settings determining module 25, a system settings updating module 26, and a program updating module 27.

The program receiving module 20 is used for receiving a new program to be updated (hereinafter “the new program”) from the receiving unit 11, and storing the new program in the first storage 10. The calculating module 21 is used for calculating a value by adding all American Standard Code for Information Interchange (ASCII) data of the new program. The program checking module 22 is used for reading a predetermined value of the new program from the first storage 10, and determining whether the new program is valid by comparing the calculated value with the predetermined value. The format determining module 23 is used for reading a first format description file and a second format description file from the first storage 10, and determining whether the new program is compatible with a corresponding old program in the first storage 10 by comparing the first format description file with the second format description file. Wherein, the first format description file describes a data format (such as a data encoding mode, a single byte type, or a double bytes type) of the new program, and the second format description file describes a data format of the old program. The format converting module 24 is used for converting a data format of the new program to a corresponding data format which can be compatible with the old program according to a format reference file stored in the first storage 10. The system settings determining module 25 is used for reading a first system settings description file and a second system settings description file from the first storage 10, and determining whether the new program is compatible with system settings of the computer by comparing the first system settings description file with the second system settings description file. Wherein, the first system settings description file stores the system settings which can be compatible with the new program; and the second system settings description file stores the system settings of the computer. The system settings updating module 26 is used for updating the system settings of the computer to the system settings which can be compatible with the new program according to a system settings reference file stored in the first storage 10. The program updating module 27 is used for updating the old program by the new program in the first storage 10.

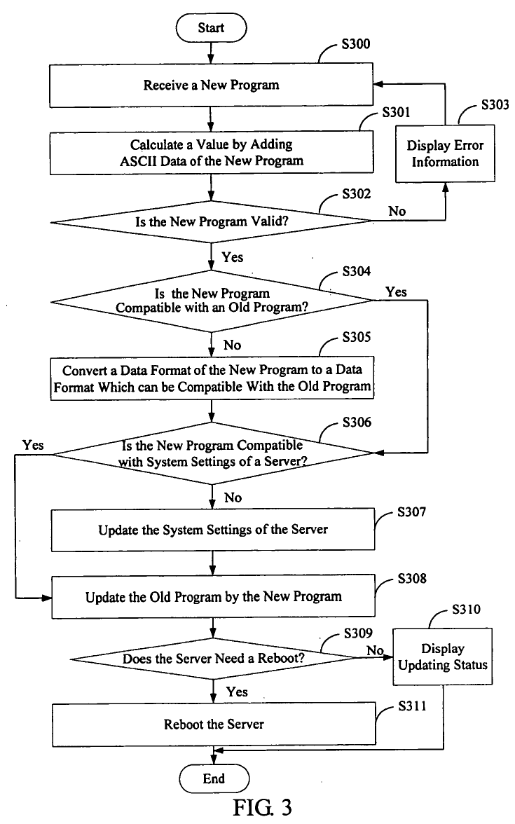

FIG. 3 is a flowchart of a preferred method for updating a program automatically by implementing the system of FIG. 2. In step S300, the program receiving module 20 receives a new program from the receiving unit 11, and stores the new program in the first storage 10. In step S301, the calculating module 21 obtains a value by adding all ASCII data corresponding to the new program. In step S302, the program checking module 22 reads a predetermined value of the new program from the first storage 10, and determines whether the new program is valid by comparing the calculated value with the predetermined value. If the calculated value is not equal to the predetermined value, which means the new program is not valid, in step S303, the display unit 14 displays error information, then the procedure returns to step S300. Otherwise, if the calculated value is equal to the predetermined value, which means the new program is valid, in step S304, the format determining module 23 reads a first format description file and a second format description file form the first storage 10, and determines whether the new program is compatible with a corresponding old program in the first storage 10 by comparing the first format description file with the second format description file. If the new program is compatible with the old program, the procedure goes directly to step S306 described below. Otherwise, if the new program is not compatible with the old program, in step S305, the format converting module 24 converts a data format of the new program to a corresponding data format which can be compatible with the old program according to a format reference file stored in the first storage 10. In step S306, the system settings determining module 25 reads a first system settings description file and a second system settings description file from the first storage 10, and determines whether the new program is compatible with system settings of the computer by comparing the first system settings description file with the second system settings description file. If the new program is compatible with the system settings of the computer, the procedure goes directly to step S308 described below. Otherwise, if the new program is not compatible with the system settings of the computer, in step S307, the system settings updating module 26 updates the system settings of the computer to the system settings which can be compatible with the new program according to a system settings reference file stored in the first storage 10. In step S308, the program updating module 27 updates the old program by the new program. In step S309, the processor 12 determines whether the computer needs a reboot. If the computer does not need a reboot, in step S310, the display unit 14 displays updating status information, and the procedure is ended. Otherwise, if the computer needs a reboot, in step S311, the processor 12 reboots the computer, and the procedure is ended.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for automatically updating a program in a computer, the computer comprising a processor and a storage, the program updating system comprising:
a format determining module for determining-whether a new program to be updated is compatible with a corresponding old program in the storage by comparing a first format description file with a second format description file in the storage;
a format converting module for converting a data format of the new program to a corresponding data format which can be compatible with the old program according to a format reference file in the storage;
a system settings determining module for determining whether the new program is compatible with system settings of the computer by comparing a first system settings description file with a second system settings description file in the storage;
a system settings updating module for updating the system settings of the computer to system settings which can be compatible with the new program according to a system settings reference file in the storage; and
a program updating module for updating the old program in the storage by the new program.

2. The system according to claim 1, further comprising a program receiving module for receiving the new program, and storing the new program in the storage.

3. The system according to claim 1, further comprising a calculating module for calculating a value by adding American Standard Code for Information Interchange (ASCII) data of the new program.

4. The system according to claim 3, further comprising a program checking module for determining whether the new program is valid by comparing the calculated value with a predetermined value of the new program in the storage.

5. The system according to claim 1, wherein the first format description file describes a data format of the new program.

6. The system according to claim 1, wherein the second format description file describes a data format of the old program.

7. The system according to claim 1, wherein the first system settings description file stores the system settings which can be compatible with the new program.

8. The system according to claim 1, wherein the second system settings description file stores the system settings of the computer.

9. A method for automatically updating a program in a computer, comprising the steps of:
receiving a new program, and determining whether the new program is compatible with a corresponding old program by comparing a first format description file with a second format description file in a storage of the computer;
converting a data format of the new program to a data format which can be compatible with the old program according to a data format reference file in the storage, if the new program is not compatible with the old program;
determining whether the new program is compatible with system settings of the computer by comparing a first system settings description file with a second system settings description file in the storage;
updating the system settings of the computer to system settings which can be compatible with the new program according to a system settings reference file in the storage, if the new program is not compatible with the system settings of the computer; and
updating the old program in the storage by the new program.

10. The method according to claim 9, further comprising a step of receiving the new program, and storing the new program in the storage.

11. The method according to claim 9, further comprising a step of calculating a value by adding American Standard Code for Information Interchange (ASCII) data of the new program.

12. The method according to claim 11, further comprising a step of determining whether the new program is valid by comparing the calculated value with a predetermined value of the new program in the storage.

13. A method for automatically updating a program in a computing system, comprising the steps of:
retrieving an update of a program executable in a computing system;
converting data format of said update so as to be compatible with said program when said data format of said update is not compatible with said program;
updating system settings of said computing system according to said update when said update is not compatible with said system settings; and
updating said program by means of said update.

14. The method according to claim 13, further comprising the step of verifying validity of said retrieved update before said converting step.
